(19) United States
(12) Patent Application Publication
(10) Pub. No.: US 2005/0079250 A1
(43) Pub. Date: Apr. 14, 2005

(54) Food packaging allowing the food to be steam cooked

(75) Inventors: Nolwenn Mao, Lichfield (GB); Mark Newton, Alfreton (GB); Sylvain Finel, Agon Coutainville (FR)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: SOLECO SOCIETE LEGUMIERE DU COTENTIN, LESSAY (FR)

(21) Appl. No.: 10/938,127

(22) Filed: Sep. 10, 2004

(30) Foreign Application Priority Data
Sep. 12, 2003 (FR) 03-10757

(51) Int. Cl. A23B 4/00

(52) U.S. Cl. 426/113

(57) ABSTRACT

Food packaging comprising a container containing food and having an upper opening allowing access to the food, and first removable closure means for the upper opening, an end wall comprising at least one perforated zone having holes that can prevent food from passing through while allowing the passage of steam, the packaging comprising second removable closure means that can close off the holes, the second closure means being accessible from the outside. The packaging also comprises a solid skirt, projecting out from the container surrounding the perforated zone, and having at least one opening, the skirt promoting the passage of steam towards the perforated zone and towards the container.

### CROSS-REFERENCE TO RELATED APPLICATIONS

This application is based upon and claims priority from French Patent Application No. 03-10757, filed Sep. 12, 2003, the entire disclosure of which is herein incorporated by reference.

### FIELD OF THE INVENTION

The present invention relates to packaging for food, in particular packaging designed to preserve food and that is ready to use to steam cook the food.

### BACKGROUND OF THE INVENTION

Some food, prepared or otherwise, is sold ready-to-eat, packaged in individual packaging. The consumer opens the packaging and takes out the food contained in the packaging so as to prepare it.

Packaging can be provided that is designed for the food to be cooked directly in the packaging. It is possible, for example, to provide packaging comprising a container and a sealing film, which packaging, once opened by removing the film, may be placed directly in a conventional oven or microwave oven for cooking.

Steam cooking is a healthy way of cooking food that preserves the nutritional content of the food. Pressure cookers are generally used to steam cook food. This requires the food to be handled in order to transfer it to the pressure cooker. It also requires one to have a pressure cooker. Furthermore, these pressure cookers generally consist of many parts that have to be cleaned after each use to ensure satisfactory hygiene. These handling and other operations are not in line with consumers' desire for food that is ready to eat or ready to cook, particularly directly in its packaging.

### SUMMARY OF THE INVENTION

One aim of the present invention is to provide food packaging that can be used directly to steam cook the food it contains.

Such food packaging, for steam cooking food, comprises a container containing food and having an upper opening allowing access to the food, and first removable closure means for the upper opening. An end wall comprises at least one perforated zone having holes that can prevent food from passing through while allowing the passage of steam, the packaging further comprising second removable closure means that can close off the holes, the second closure means being accessible from the outside. The packaging also comprises a solid skirt, projecting out from the container surrounding the perforated zone, and having at least one opening, the skirt promoting the passage of steam towards the perforated zone and towards the container.

The inside of the container of the packaging is isolated from the external environment as long as the first and second closure means are closing off the upper opening and the holes of the perforated zone. A controlled atmosphere can be maintained inside the container to ensure the food is preserved. The packaging can thus be displayed on a shelf without the risk of contamination from the external environment.

To steam cook the food directly in the packaging, all a user has to do is remove the second closure means, thus freeing the holes, and place the packaging above a source of steam, such as a body of boiling water, for example in a saucepan. The second closure means accessible from the outside may be removed while keeping the first closure means closed. The steam produced by the steam source can penetrate the container via the holes, the steam not escaping via the upper opening, which remains closed. Thus, the food contained in the container is kept in a saturated steam atmosphere and is “steam” cooked. The food may be packaged in the packaging in the raw or pre-cooked state.

To eat the cooked food, the user removes the first closure means, freeing the upper opening.

Packaging comprising such a skirt having at least one opening has the advantage that, when the container is placed in a body of boiling water, it helps the steam to pass through the food and into the container, improving cooking, and allowing rapid steam cooking. Specifically, the skirt limits the escape of steam from the container by directing the steam directly towards the food, thus substantially reducing the cooking time.

With such packaging, it is not necessary to have a specific water vessel that is specially shaped to receive the packaging for cooking the food, since by virtue of the opening in the skirt, the packaging may be placed in a plurality of receptacles containing a body of boiling water. The packaging is therefore particularly economical.

The second closure means may advantageously close off the free end of the skirt, thus making it easier to access and remove the second closure means.

Such packaging thus has the advantage of substantially reducing the risk of any contamination of the skirt, while the packaging is being stored or displayed on a shelf, by items that could stick to the inner wall of the skirt and pass through the holes of the perforated zone as the food is cooked.

Advantageously, first and/or second closure means are provided in the simple form of a welded or adhesively bonded sealing film.

Preferably, the second closure means and the skirt delimit a closed space containing food accompaniments.

Such packaging has the advantage of being able to comprise, in a unitary assembly, with a relatively low risk of loss, items that may accompany the food to be steam cooked, without it being necessary to provide a specific attachment element, the items being placed inside the closed space defined between the end wall of the container and the lower sealing film.

Advantageously, the axial dimension of the skirt is between 20% and 50% of the axial dimension of the container.

In one embodiment, the container and the skirt are in one piece. Such packaging is particularly economical.

Advantageously, the packaging comprises at least one integrated handle articulated between a position in which it is folded down against the container and a position at a distance from the latter. The integrated handle makes it easier to retrieve the packaging once the vegetables are cooked. The articulated handle may be kept at a distance from the container during cooking to prevent it from being heated up with the container. Means may be provided to keep the handle at a distance from the container during cooking.

In one embodiment, the packaging comprises a rim surrounding the upper opening and having grip members precut in the rim and articulated to fixed elements of the rim via hinges so that they can be brought into the upright position.

In one embodiment, the grip members comprise fastening means that can cooperate with one another to keep the members upright.

In one embodiment, the hinges are formed by thinned regions of the rim that deform easily without the risk of breaking.

### BRIEF DESCRIPTION OF THE DRAWINGS

The present invention and its advantages will be more clearly understood on reading the detailed description of an embodiment taken by way of non-limiting example and illustrated by the attached figures, in which:

FIG. 1 is a view in axial section of packaging according to one aspect of the invention;

FIG. 2 is a top view of the packaging according to FIG. 1;

FIG. 3 is an exploded schematic view in axial section of the packaging according to FIG. 1 showing steps in the packaging process;

FIG. 4 is a detailed side view of the packaging according to FIG. 1, with upright handles; and

FIG. 5 is a schematic view in axial section of the packaging according to FIG. 1 during a step of steam cooking the food, directly in the packaging.

### DETAILED DESCRIPTION OF PREFERRED EMBODIMENTS

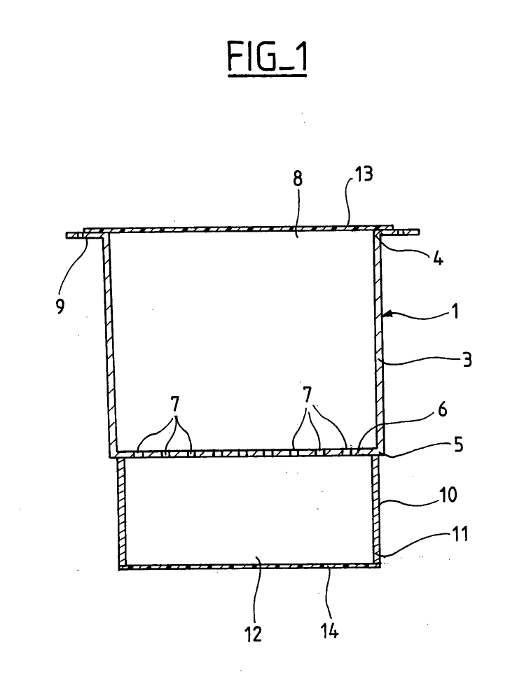

In FIG. 1, food packaging according to the invention comprises a container 1 of generally annular shape, the container 1 being delimited by a cylindrical peripheral wall 3 having an upper axial end 4 and a lower axial end 5, and by a flat radial end wall 6 extending from the lower end 5 of the peripheral wall 3. The peripheral wall 3 is solid and has no holes. The end wall 6 is perforated with holes 7 distributed over a central zone of the end wall 6 except at its peripheral edge, such that the end wall 6 only partially closes off the lower end 5 of the container 1. In other words, the holes 7 are offset radially inwards from the inner edge of the peripheral wall 3. The upper axial end 4 of the peripheral wall 3 delimits an upper opening 8.

The packaging comprises a rim 9 projecting radially outwards from the upper end 4 of the container 1 and incorporating fold-out grip means that will be described in more detail below.

The packaging comprises a rigid cylindrical support skirt 10 that is coaxial with the container 1, the skirt 10 projecting from a peripheral edge of the end wall 6 on the opposite side from the container 1. The diameter of the skirt 10 is slightly smaller than that of the peripheral wall 3 of the, container, such that there is a slight step between the outer surface of the peripheral wall 3 and the outer surface of the skirt 10. In other words, the radial dimension of the skirt 10 is smaller than the radial dimension of the container 1. The axial dimension of the skirt 10 is also in this case smaller than the axial dimension of the container 1. It is however necessary to provide a skirt 10 whose axial dimension is sufficient to allow the container 1 to be placed in a body of boiling water for rapidly cooking the food, without the water coming into contact with the food contained in the container 1. Preferably, the axial dimension of the skirt 10 is between 20% and 50% of the axial dimension of the container 1.

The holes 7 are in the zone of the end wall 6 that is delimited by the intersection between the end wall 6 and the skirt 10. A free end edge 11 of the skirt 10 delimits a lower opening 12 of the packaging. In other words, the skirt 10 has no end wall on the opposite side from the container 1. The wall of the skirt 10 is solid and has no holes.

The peripheral wall 3, the end wall 6 and the skirt 10 are in one piece and may advantageously be made of any suitable packaging material that is harmless to food but also capable of withstanding temperatures above 100° C. without contaminating the food. The peripheral wall 3, the end wall 6 and the skirt 10 may advantageously be made of a rigid synthetic material.

The upper opening 8 is closed off by first closure means in the form of an upper sealing film 13 that is welded around its periphery to the rim 9. The lower opening 12 is closed off by second closure means, here in the form of a lower sealing film 14 welded around its periphery to the free end edge 11 of the skirt 10. The upper and lower sealing films are advantageously made of flexible synthetic material.

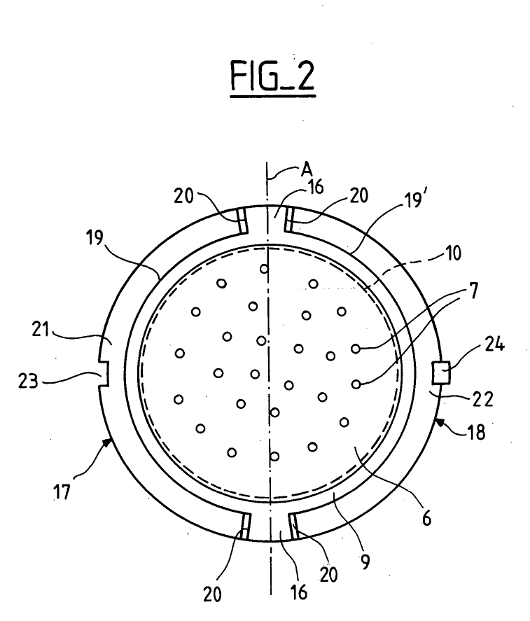

In FIG. 2, where the packaging is shown without the upper sealing film, the end wall 6 has a plurality of holes 7 uniformly distributed over the end wall 6.

The rim 9 has two diametrically opposed fixed tabs 16 and two integrated handles 17, 18 precut in the rim 9 and articulated to the fixed tabs 16, the integrated handles 17, 18 being substantially symmetrical about the axial plane A passing through the fixed tabs 16.

An integrated handle 17, 18 is in the shape of an arch with a substantially semicircular profile, the ends of which are connected by hinges 20 having an axis parallel to the plane of symmetry A and made here in the form of thinned regions or connections of the rim 9. An arch 17, 18 is formed by precutting, being separated from the rim by a precut line 19 describing a circular arc. The arch 17, 18 lies in the plane of the rim 9 and is joined to the latter by temporary connecting means forming a weaker region, for example one or more connecting points distributed along the precut line 19. The arches 17, 18 have central regions 21, 22. The arches 17 and 18 differ in that the central region 21 of the arch 17, to the left in FIG. 2, has a cut-out 23 on an outer edge, the central region 22 of the other arch 18, to the right in FIG. 2, being symmetrically provided with an elastic snap-fastening hook 24 that can cooperate with the cut-out 23.

The arches 17, 18 form grip members that are precut in the rim 9, aligned with the rim 9 in an initial folded-down position and able to be articulated to thin connections 20 and brought into the upright position in which the central regions of the arches 17, 18 are at a distance from the container 1.

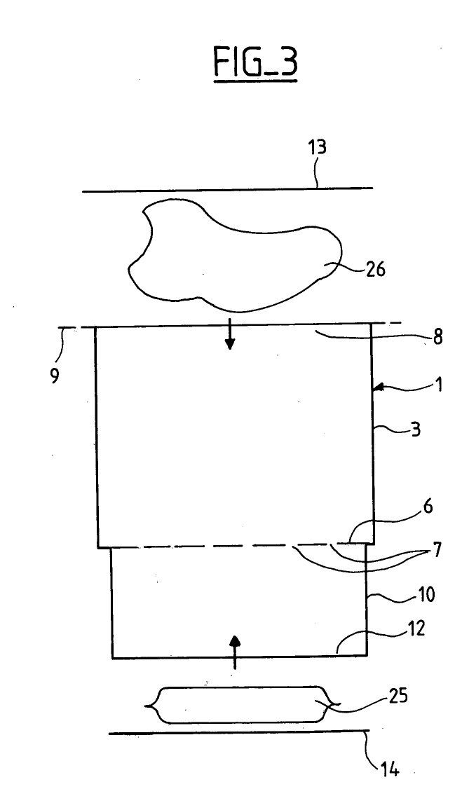

FIGS. 3 to 5 show how the packaging works, the numerical references for elements similar to those of FIGS. 1 and 2 having been retained in these figures.

As shown in FIG. 3, during the packaging process, raw or pre-cooked food is placed in the container 1. The packaging is then closed, preferably in a controlled atmosphere, for example in an atmosphere low in O₂ and rich in CO₂, to prevent oxidation of the food and prolong its preservation while preserving its appearance, by closing off the upper 8 and lower 12 openings using the upper 13 and lower 14 sealing films. The sealing films may be fastened respectively to the rim 9 and to the end edge 11 by welding, adhesive bonding, or any other appropriate means.

The skirt 10 and the lower sealing film 14 thus delimit a lower space lying radially inside the skirt and axially between the end wall 6 of the container 1 and the lower sealing film 14. As shown in FIG. 3, this closed space may advantageously be used to place, inside the packaging, items to accompany the food 26, such as sachets 25 of prepared sauces or condiments to be used with the food once it has been cooked.

The packaging, hermetically sealed by the sealing films 13, 14, can be easily transported and placed on sales shelves without the risk of contamination of the food.

To prepare the food, a user starts by removing the closure means from the perforated zone of the wall of the container, in this case by removing the lower sealing film 14. If sachets have been placed in the lower space, the user removes them.

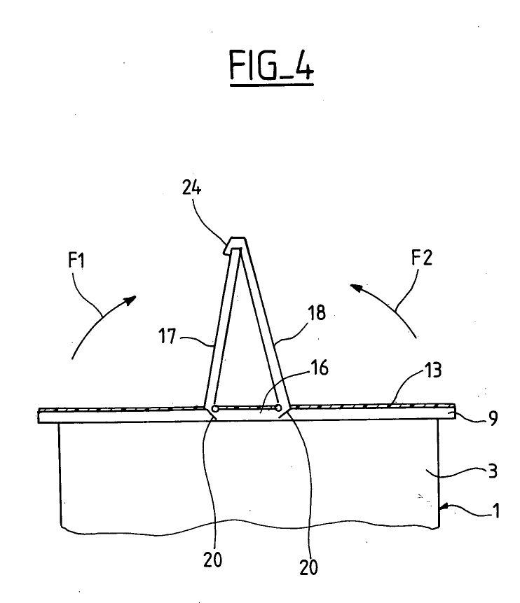

Next, as shown in FIG. 4, the user may lift the integrated handles. To this end, the user breaks the points that fasten the arches 17, 18 to the rim 9, without piercing the upper sealing film 13, and pivots the arches 17, 18 upwards about the hinges 20, by folding the latter, as shown by the arrows F1 and F2, so as to bring the central regions of the arches 17, 18 closer together until the central regions are brought into contact by snap-fastening the hook 24 of one central region 21 in the corresponding cut-out in the other central region 22. The hook 24 retains the arches 17, 18, which are thus held reciprocally in the upright position and are prevented from falling back down.

Note that the upper sealing film 13 is preferably fastened to the rim 9 without overlapping the integrated handles 16.

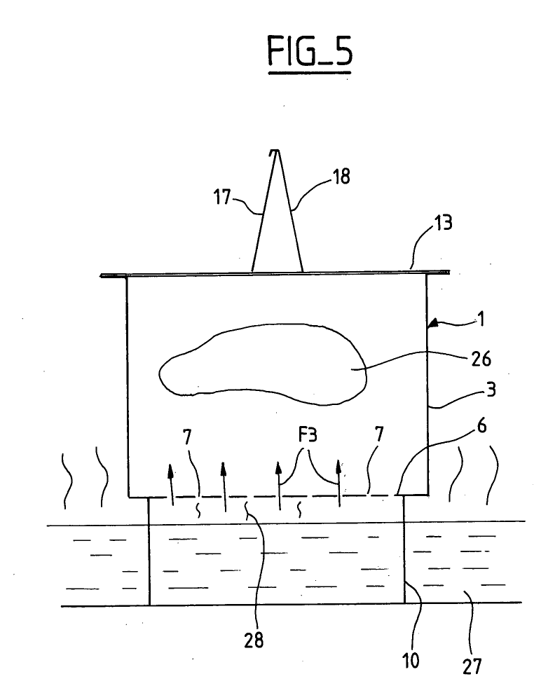

Next, as shown in FIG. 5, after having brought a layer of water 27 to boiling point in a cooking utensil such as a saucepan, the user places the packaging in the saucepan, resting on the skirt 10. The layer of water 27 is lower than the height of the skirt 10 so that the end wall 6 is out of the water and the vegetables are kept out of the water. The steam 28 produced by the boiling water lying under the skirt 10 is trapped under the skirt 10 and rises up, through the holes 7 in the end wall 6, into the container 1, as shown by the arrows F3. The steam is prevented from escaping by the upper sealing film 13. The food 26 contained in the container 1 is thus steam cooked.

When the food is cooked, the user may retrieve the packaging without the risk of burning by picking it up via the central regions of the arches 17, 18 which are kept cooler than the container 1 owing to their distance from the container 1. The user can then remove the upper sealing film 13, and retrieve the food.

The packaging may be made of any material that is suitable for packaging food and that is harmless to food and can withstand temperatures of around 100° C. or above without contaminating the food.

The holes made in the end wall may have various shapes, provided their dimensions allow the steam to pass through but not the food. Substantially circular holes may have a diameter of 0.1 to 5 mm, especially 0.5 to 3 mm.

The hinges 20 provided in the form of thin connections are more extensive and therefore stronger than the very limited fastening points, which means they do not break when the fastening points are broken. Furthermore, when they are deformed by folding, the hinges 20 do not break because they are thin. The precut integrated handles are simple and of low manufacturing cost.

Although in the embodiments illustrated the closure means are provided in the form of sealing films, other removable closure means may of course be envisaged.

The skirt and the container may be made as one piece, for example by injection moulding. Separate elements, fastened by snap-fastening or heat welding, may also be envisaged.

The invention provides a container not only for packaging but also for cooking food, the packaging comprising a skirt that substantially extends the container so as to direct the steam towards the food to be cooked so as to cook the food rapidly. In other words, the solid skirt, intended to come into contact with the bottom of the receptacle containing the body of boiling water, directly conveys the steam to the food.

Such food packaging makes it possible to steam cook food directly in the packaging, without the need for special equipment and without dirtying numerous utensils.

1. Food packaging comprising a container containing food and having an upper opening allowing access to the food, and first removable closure means for the upper opening, an end wall comprising at least one perforated zone having holes that can prevent food from passing through while allowing the passage of steam, the packaging comprising second removable closure means that can close off the holes, the second closure means being accessible from the outside, wherein the packaging also comprises a solid skirt, projecting out from the container surrounding the perforated zone, and having at least one opening, the skirt promoting the passage of steam towards the perforated zone and towards the container.

2. Packaging according to claim 1, wherein the second closure means close off the free end of the skirt.

3. Packaging according to claim 2, wherein the first and/or second closure means comprise a welded or adhesively bonded sealing film.

4. Packaging according to claim 2, wherein the second closure means and the skirt delimit a closed space containing food accompaniments.

5. Packaging according to claim 1, wherein the axial dimension of the skirt is between 20% and 50% of the axial dimension of the container.

6. Packaging according to claim 1, wherein the container and the skirt are in one piece.

7. Packaging according to claim 1, wherein it comprises at least one integrated handle articulated between a position in which it is folded down against the container and a position at a distance from the latter.

8. Packaging according to claim 7, wherein it comprises a rim surrounding the upper opening and having grip members precut in the rim and connected to fixed elements of the rim via hinges so that they can be brought into the upright position.

9. Packaging according to claim 8, wherein the grip members comprise retaining means that can cooperate with one another.

10. Packaging according to claim 8, wherein the hinges are formed by thinned regions of the rim.
